(19) United States
(12) Patent Application Publication
(10) Pub. No.: US 2010/0213405 A1
(43) Pub. Date: Aug. 26, 2010

(54) Composition and process for removal of contaminants from water and wastewater(s)

(76) Inventor: David Allen Wensloff, Oakhurst, CA (US)

Correspondence Address: David A. Wensloff, 40803 Greenwood Way, Oakhurst, CA, 93644, US

(21) Appl. No.: 12/284,863

(22) Filed: Sep. 26, 2008

(51) Int. Cl. C02F 5/10; C02F 5/08

(52) U.S. Cl. 252/181; 252/175

(57) ABSTRACT

A composition of ingredients and application process that enables the removal of contaminants from water or wastewaters, the composition when added and mixed with water(s) sequences to coagulate, flocculates and ion exchange with the composite materials. The application process is the addition of the composite material to water or wastewater where the contaminated materials are removed from the water(s) and contained in a solid material for disposal. The application is for clarification of potable waters for solids, clarification and settling aid for municipal wastewater waters, and contaminant and solids removal from industrial wastewaters.

The composition has been tested and proven to work in raw water clarification from lakes, rivers or well water, clarification of primary and secondary solids in municipal wastewater, and a wide variety of industrial wastewaters

### BACKGROUND OF THE INVENTION

1. Field of the Invention

The present invention relates to a chemical composition and its use for removal of water and wastewater including those from a publicly owned treatment works (POTW or municipality) and industrial sources containing high levels of contaminants such as suspended solids (colloidal and larger), fats, oils, greases, soluble and insoluble heavy metals, soluble and insoluble pigments, organic matter and inorganic matter. The composition includes natural minerals such as clay and trace minerals, coagulants, and flocculants (which are either cationic or anionic in nature).

2. Description of Prior Developments

Prior developments are based on the conventional physical chemistry approach of pH adjusting to the desired pH setpoint using acids or alkaline compounds (such as sodium hydroxide, potassium hydroxide, calcium hydroxide or magnesium hydroxide), then the addition of a coagulant followed by rapidly mixing, followed by the addition of a flocculant to agglomerate the coagulated particles together thus separating the contaminated compounds in a floc for liquid/solids separation.

These waste streams contain a variety of contaminants as simple as suspended colloidal solids as in raw water clarified for drinking water to heavy industrial wastewater that can contain fat, oil, grease, heavy metals, organic/inorganic substances at levels that are hazardous and often toxic to the environment and pose a risk to public health. Municipalities and Industries are regulated by the United States Environmental Protection Agency (USEPA) and governmental laws to include the Clean Water Act as well as specified industries as defined by the Code of Federal Regulations, Section 40 (CFR-40). These laws defined the level of allowable discharge to the environment or for industries the level of treatment required prior to discharge to a municipal wastewater facility.

Waste streams are currently treated by a process commonly known as physical chemistry. This is defined as the addition of chemicals to change the physical nature of the wastewater. The traditional approach is pH adjustment, coagulation (including emulsion breaking of oil/water solutions) and flocculation. This is followed by a liquid/solid separation step whether the solids are floated to the top of the contact vessel for skimming or settled to the bottom of a clarifier for settling and removal as a sludge. Metals removal might require a step after ph adjustment and that is the addition of a metal precipitate to make soluble metals insoluble, especially if the industry is using a solubility extender such as EDTA or similar chemistry (common in the plating industry). Post treatment using biological systems to further reduce the organics is not covered in this patent.

This conventional physical chemistry process highly variable in the effluent water quality because it is difficult to control, there are many steps to the process with each being a potential bottleneck and it is very labor intensive. The limitations are usually from operator error, instrumentation that is not calibrated or dysfunctional, swings in the incoming flow or load (metal organic, and inorganic content) and other factors.

A key factor that industry does not realize is the importance of the pH adjusting step to the right setpoint and the correct dosage of the coagulant. Each waste stream has a different Zeta potential (the charge necessary at the right pH to meet the neutralize charge of the contaminating constituent) and the Zeta potential varies with pH, and organic/inorganics loading. Since the Zeta potential varies, the pH and coagulation setpoint and dosages need to vary. Unfortunately, the instrumentation to do this does not exist in a marketable form for industry to afford. Therefore, there are limitations to the conventional physical chemistry process.

Another limitation to conventional physical chemistry is the solids generated cannot retain the contaminants that are removed from the waste stream when they are landfilled. The USEPA requires a sludge testing protocol for the leachability of sludge depending on their CFR-40 classification and categorical industry standard and analytical testing. Based on past results, industries are classified as hazardous or nonhazardous by the leachability of their sludges. Hazardous sludges require special handling and manifests and must go in regulated landfills at a great expense to the hazardous waste generator.

The use of chemical agents for treating wastewater is disclosed in U.S. Pat. Nos. 3,956,117, 3,428,558, 3,968,036, 4,167,481, 4,517,094, 5,336,704, and 5,415,808. These earlier inventions, however, suffer from disadvantages relating to their limited applications, i.e., the chemical agents are not stand-alone products. For example, U.S. Pat. No. 3,956,117 discloses the use of cationic polymers for removal of oil; U.S. Pat. Nos. 3,428,558, and 5,415,808 disclose polymeric flocculants and their use in the removal of suspended particles; U.S. Pat. Nos. 4,167,481 and 5,336,704 disclose chemical compositions for removal of metals; and U.S. Pat. Nos. 3,968,036 and 4,517,094 disclose methods for removal of organics.

None of these earlier inventions discloses a single agent or composition that is capable of simultaneous removal of contaminants such as oil and grease, suspended solids, heavy metals, and other organic and inorganic matter. Moreover, in most cases, prior treatment processes are also tedious and laborious such as those disclosed in U.S. Pat. Nos. 4,167,481 and 4,517,094 or those inventions wherein a conventional multi-step process is required when polymeric flocculants are used. Most importantly, these earlier inventions are not cost effective and generate solid wastes that are normally hazardous and must be further treated prior to disposal. More recently, attention has been focused on the development of a single product system for treatment of waste streams, such as disclosed in U.S. Pat. Nos. 3,953,330, 4,332,693, 4,415,467, 4,650,590, 4,757,040, 4,765,908, 5,810,920, 5,880,060, 6,132,625, 6,159,380, 6,180,023, 6,190,561, 6,716,366 and 7,410,588. These products suffer from disadvantages due to non-versatility, i.e., they are generally applicable to a specific type of waste stream, e.g., oil, metals, or organic contaminated waste streams. Their compositions are different formulations using catalyst (such as boron, zirconia, alumina, potassium, sodium silicate, sodium aluminate, silica gel, radiant isotopes and others), oxidizing agents, metal precipitants in the form of sulfides or triazines, acidification, pH adjusting agents such as lime, dolomite lime, and cements and other formulations that perform a different set of reactions and are much more limited in their contaminant removal efficiency. Some are designed to be made into slurries and not fed as a dry product. Moreover, their manufacturing processes are complex, the compositions work in a narrow range of pH, they are slow to react with contaminants, and they produce solid waste that may not pass the Toxicity Characteristic Leaching Procedure (TCLP) test protocol instituted by the US USEPA. Some are “modified clays” where liquid solutions containing chemical additives such as quartenary ammonium and other compounds to make “activated or organoclays, which perform differently and are not comparable in nature to this invention.

More recent single products to treat wastewaters is disclosed in U.S. Pat. No. 6,180,023. These products suffer from their complexity of composition in the use of aluminum silicate, cement, flyash, phosphate rock, silica fume and other ingredients.

There is a need to have a single product (composition) that can remove water soluble and insoluble contaminants from water and wastewaters. Conventional chemistries require a lot of operator attention to maintain the correct dosage, proper pH range and other process variants to efficiently remove these contaminants.

The composition needs to be capable of removing more contaminants than conventional chemistries resulting in a lower treated water contaminant concentration.

There is a need for a treatment process to have a wider treatibility range without adjusting the dosage to meet the exact Zeta potential as required by conventional coagulation technologies.

The composition needs to be cost effective in cost/gallon treated as compared to conventional chemistries.

The composition needs to form a strong floc that can withstand floc shear (maintain its floc properties and not break down) due to water flow or pumping.

The composition needs to form a floc as rapidly as conventional chemistries.

The composition needs to form a large floc for easier liquid/solids separation as compared to conventional chemistries.

The composition needs to settle quicker in clarification processes and/or rise faster and float better when in a floatation liquid/solid separation process as compared to conventional chemistries.

In order to enhance the removal efficiency of the contaminants, the composition needs to simultaneously coagulate, flocculate and undergo an ion exchange with the contaminants in the water.

A need exists for such a single treatment agent which when dewatered creates a drier sludge cake.

A need exists for a single treatment product that does not add significant amounts of total dissolved solids (TDS) or electroconductivity (EC) to the treated water as compared to conventional chemistry processes, thereby allowing water reuse.

A need exists for a single product that is non hazardous and safe to use with minimal risk to the operators.

A need exists for a process that removes hazardous contaminants from a waste stream and isolates them in a stabilized non-leaching mica layer matrix.

A need exists for such an agent and process which generates solid waste that does not require further treatment in order to pass the Toxic Characteristic Leaching Procedure (TCLP) and Standard Toxic Leaching Compounds (STLC) tests and can be reclassified as non-leaching and non hazardous and therefore does not pose a hazard to the environment once disposed of in a landfill.

A need exists for such a composition that is very versatile and works effectively over a wide pH range between a pH of 4-12.

A further need exists for a composition that can remove contaminants in oil emulsion, surfactants, detergents, hardness, saline, and chelating/complexing agents laden waters.

### SUMMARY OF THE INVENTION

The present invention, does indeed meet all of the above outlined criteria of needs for a single product. The application of the product is typically either in a batch treatment process or a continuous treatment process.

The product is a dry granular or powder product that is fed to the treatment process with a volumetric feeder. The dosage rate of the product is set on the feeder whether by timer in batch treatment of at a constant rate for continuous treatment processes. The dosage rate of the product is predetermined using jar testing techniques and USEPA certified lab techniques for verification of contaminant removal efficacy. Actual full scale analytical testing needs to be performed for verification.

In a batch process, a treatment tank is typically filled with the wastewater, a mixer is used to agitate the wastewater to make a uniform and homogeneous liquid, and the product is added to the water in the treatment tank, mixed for 2-15 minutes until a floc is formed and clear water is visible between the floc particles. The mixer is turned off, the solids settle, the clear water is decanted off and the solids on the bottom are dewatered.

In a continuous process, the product is fed into a mix tank for mixing and flows with the wastewater to the liquid/solid separation process (settling as in a clarifier or floating as in an air flotation process). In some applications, the product is slurried by using untreated wastewater as a carrier of the dry product and it is then pumped into a pressurized pipe, common with dissolved air floatation systems.

The sludge generated can be dewatered using a filtration system such as a vacuum filtration system, dewatering table, centrifuge, belt press, screw press and a filter press. Treated water is drained off and released or recycled for reuse and the solid waste is hauled away without the need for sludge stabilization or further treatment.

An object of the invention is its ability to quickly form a large floc where parabolic and/or rotary screens can be used as the liquid/solid separation process. These applications include flume water systems where the water is returned to the flumes, wood pulp recovery where the screened pulp is reused, oil recovery, and sludge recycle for rendering facilities.

A further object of this invention is to provide a treatment technology that produces treated water with sufficient quality to reuse such as in paper making, corrugating, pressure washing, edible raw food conveying flumes (e.g. such as potato, tomato, carrot), hide washing, and wash down operations.

A treatment agent for the remediation of waste streams has been developed in accordance with this invention for simultaneously removing virtually all contaminants in the waste stream. Contaminants removed by the treatment agent include fats, oil, grease, other organic matters, suspended solids, and soluble heavy metals as defined in the USEPA Methods for CAM 17 metals (antimony, arsenic, barium, beryllium, cadmium, chromium, cobalt, copper, lead, mercury, molybdenum, nickel, selenium, silver, thallium, vanadium and zinc), as well as other positive metal ions such as aluminum, gold, iron, manganese, tin, titanium as well as radioactive elements and isotopes such as uranium, thorium, and plutonium.

Another object of the inventions is its ability to retain precious metals (gold, silver, platinum) from waste streams which can be dewatered and smeltered to recover the precious metal value. In addition, the treatment agent and process according to the invention are effective in removing negative ions such as nitrates, sulfates, fluorides, phosphates, hexavalent chromium, and arsenic. The treatment agent also removes levels of ammonia, organic carbon compounds, and other contaminants.

Furthermore, the compositions of this invention are effective in lowering the levels of chemical oxygen demand (COD) and biological oxygen demand (BOD) in waste streams more efficient and to lower treatment levels than conventional chemistries.

The composition is designed and performs well in rapid formation of a stable floc. The reactions are carefully formulated to coagulate, flocculate and undergo and ion exchange where some of the contaminants are adhered into the natural clay mica layers resulting in a higher removal efficiency of contaminants. In addition, since the contaminants are held as part of an ion exchange, the sludge is nonleachable of these contaminants when tested in accordance to the USEPA TCLP/STLC testing protocols.

The present invention is more cost effective in cost/gallon treated than conventional chemistries. The product dissolves and reacts quickly to remove contaminants from wastewater. The result is a higher quality treated effluent that meets and usually exceeds the discharge standards for sanitary discharge, requirements for reuse, or requirements for direct land application (irrigation or disposal). The sludge formed produces a stabilized nonleaching solid waste.

The treatment composition of this invention is also effective over a wide waste stream pH range from 4-12 pH. pH adjustment is usually required to meet the discharge pH range generally between 6 and 9 pH.

The product reacts quickly and floc formation starts almost immediately. The more mixing energy, the quicker the product reacts to remove the contaminants. The formation of the floc in the water is stable and does not break down with extended mixing.

The product has proven to not significantly increase the EC/TDS when comparing untreated and treated waters. Tests have shown an increase of 10-20% versus up to 120% with conventional chemistries.

Furthermore, the process of the present invention is simple and relatively inexpensive which makes it possible and affordable for small operators to set up their own treatment systems. This, in turn, reduces the demand put on treatment facilities such as publicly owned treatment works (POTW), and waste and waste treatment plants.

In summary, the present invention provides:

1. An efficient process for the removal of contaminants from waste streams, particularly raw water, industrial and municipal wastewaters and groundwater;
2. A single product capable of removing fats, oil, grease, heavy metals, soluble and insoluble organics, suspended solids, precious metal recovery, radioactive metals, present in waste streams;
3. A single product that can reduce levels of Biochemical Oxygen Reduction (BOD) and Chemical Oxygen Demand (COD) with treated levels far below levels achievable with conventional and other chemistries;
3. A process and composition that is capable of treating the wastewaters with varying influent contaminant loads and concentrations (Zeta potential variations);
4. A process and compositions that work over a wide pH range, i.e., 4 to 12;
5. A cost effective treatment process that can handle flow rates exceeding 5,000 gallons per minute in a continuous setup;
6. Formation of a stable, strong and dense floc that is fast settling and easy to dewater;
7. The product generates a floc that has relative high shear strength properties;
8. Formation of a stable, strong and dense floc that is easily floated in an air addition floatation process and easy to dewater,
9. The product does not contribute significantly to the EC/TDS levels of the waters;
10. A process that generates solid waste that passes the TCLP/STLC tests for sludge reclassification from hazardous to nonhazardous sludge;
11. Treated water that meets and exceeds government discharge standards;
12. Treated water of high quality that can be reused in some manufacturing processes;
13. A water and wastewater remediation process which is very economical as compared to other treatment process and conventional chemistries.

The aforementioned objects, features and advantages of the invention will, in part, be pointed out with particularity, and will, in part, become obvious from the following more detailed description of the invention.

### DETAILED DESCRIPTION OF THE PREFERRED EMBODIMENTS

The present invention is for the removal of soluble and insoluble contaminants from waters and wastewaters, both industrial and municipal. The invention is a single use product with no additional chemicals needed beyond a pH adjustment to meet the discharge pH requirement for the receiving POTW or other discharge as regulated by the USEPA. The product is a dry granular or powder form, uniform in composition and is fed using a volumetric auger feed system.

One form of the treatment composition includes, by weight percent, 15-96% natural clay, 5-40% of either organic coagulants selected from a group of low molecular weight cationic polyelectrolytes such as polyamine, polydiallyldimethylammonium chloride, and polyepichlorohydrin, etc., or inorganic coagulants selected from a group of aluminum or iron containing compounds, or combinations of the organic and inorganic coagulants; and 1-11% of flocculating agents such as anionic, cationic polymers, or combinations thereof. The amounts stated in the composition are based on the total weight of the composition.

Coagulants suitable for this invention are inorganic, organic, or combinations thereof. Inorganic coagulants include iron and aluminum containing compounds such as aluminum chlorohydrate, polyaluminum chloride, aluminum sulfate, ferric chloride, ferrous sulfate, and ferric sulfate. Organic coagulants include polymeric materials such as polyamine, polydiallyldimethylammonium chloride, and polyamine epichlohydrin.

Preferred polymeric flocculating agents include high molecular weight anionic, cationic polyelectrolytes, or combinations thereof. The preferred anionic polyelectrolytes are polyacrylamide/acrylate, maleates, methacrylates, sulfonates, and 2-acrylamido-2-methylpropane sulfonate copolymers. The preferred cationic polyelectrolytes are acrylamide copolymers of dimethyldiallylammonium chloride, dialkyl aminoethyl acrylate or methacrylate quarternized with dimethylsulfate or methyl chloride, and

methacrylamidopropyltrimethylammonium chloride or a combination thereof, and preferably polyelectrolytes of high molecular weight and most preferably polyelectrolytes between 100,000 and 5,000,000. A preferred treatment agent includes:

a. From 15 to 96% of natural clays, silica, quarts, albite, cristobalite, biotite, and mica mineral blend, or combinations thereof;
b. From 0-40% inorganic, organic coagulants or combinations thereof.
c. From 1-11% flocculating agents selected from a group which consists of anionic, cationic agents, or combinations thereof.

The following examples will further illustrate the performance of the preferred compositions in accordance with the present invention. However, it is to be understood that these examples are given by way of illustration and not limitation. These examples show and prove the removal efficacy of the invention.

### Example I

### Circuit Board Manufacturer

The product was added at a dosage of 350 ppm into a 1,000 ml beaker and mixed with a stirrer for 5 minutes. The solids were allowed to settle and the clear water on top was tested using an ICP following current USUSEPA testing methods. The results proving the increased efficiency for heavy metals removal for conventional treatment versus the invention, is shown below:

### Conventional

| Component | Untreated | Chemistry | Invention |
|---|---|---|---|
| Copper | 156 ppm | 1.2 ppm | 0.3 ppm |
| Nickel | 210 ppm | 0.9 ppm | 0.4 ppm |

### Example II

### Hazardous Wastewater Processing Facility

The product was added at a dosage of 325 lbs/18,000 gallons and recirculated for 20 minutes in a 22,000 gallon Mixing Tank. Samples were drawn from the top of the tank and analyzed using USUSEPA Methods 8260B for Total Toxic Organics (TTO), Cam 17 for heavy metals and general analytical for BOD and TDS levels. The results shown below clearly show the removal of organics (down to low parts per billion (ppb) levels), heavy metals, negligible change in total dissolved solids (TDS) with performance as claimed for this invention.

General Analysis (Units in mg/L)

| | Untreated | Treated | % Removal |
|---|---|---|---|
| BOD | 14,100 | 5,190 | 63.2% |
| TDS | 3,600 | 3,560 | Negligible |

Total Toxic Organics, USEPA Method 8260B (All Units in ppb)

| Removal | Untreated | Treated | % Removal |
|---|---|---|---|
| 1,4-Dichlorobenzene | 181 | ND | >99% |
| Ethyl benzene | 168 | ND | >99% |
| Toluene | 3,530 | 19 | 99.5% |

Total Threshold Limit Concentration, TTLC (All Units in ppm)

| | Untreated | Treated | % Removal |
|---|---|---|---|
| Antimony | ND | ND | N/A |
| Arsenic | 0.032 | ND | >99% |
| Barium | 5.64 | ND | >99% |
| Beryllium | ND | ND | N/A |
| Cadmium | 0.141 | ND | >99% |
| Chromium, Total | 2.65 | 0.025 | 99% |
| Cobalt | 0.169 | 0.036 | 79% |
| Copper | 10.2 | 0.047 | 99.5% |
| Lead | 4.51 | 0.015 | 99.7% |
| Mercury | ND | ND | N/A |
| Molybdenum | 4.79 | 1.41 | 70.6% |
| Nickel | 3.05 | 0.436 | 85.7% |
| Selenium | ND | ND | N/A |
| Silver | 0.039 | ND | >99% |
| Thallium | ND | ND | N/A |
| Vanadium | 0.167 | ND | >99% |
| Zinc | 74.1 | 0.645 | 99.1% |

### Example III

### Precious Metal Recovery

The product was added at a dosage of 10 lbs to 500 gallons of jewelry deburring rinse water. The product is thoroughly mixed for 5 minutes and the flocculated solids are allowed to settle for 15 minutes. The settled sludge is then dewatered and sent to a smeltering operation where 6.435 ounces of gold was recovered.

### Example IV

### Ground Water Remediation

The contaminated groundwater was sampled and tested in a 1,000 ml beaker with the product at a dosage of 0.25 grams in 1,000 ml of contaminated groundwater. The 1,000 ml sample with the product were mixed for 3 minutes and allowed to settle for 5 minutes. The clear water on top was decanted and tested using USEPA Methods 1664 (for hydrocarbon Oil and Grease) and 8015(M) for Total Petroleum Hydrocarbon as Diesel. The results are shown below and show the effective removal of these constituents as claimed.

| Constituent | Method | Untreated | Treated |
|---|---|---|---|
| Hydrocarbon Oil & Grease | USEPA 1664 | 6.3 | ND |
| Total Oil & Grease | USEPA 1664 | 2.0 | ND |
| TPH as Diesel | USEPA | 940 | 290 |
| | 8015 (M) | | |

### Example V

### Industrial Laundry

The facility has heavy metals in the wastewater and the product was tested at a dosage of 200 ppm with a continuous flow stream at 125 gallons/minute. The facility was using conventional chemistry in the form of sulfuric acid for pH adjustment, lime and calcium chloride for increased solids, polyaluminum chloride as the coagulant, and an anionic flocculant. The conventional chemistry could not meet the USEPA CFR 40 discharge regulations for industrial laundries. As shown in the tables below, the product outperformed the conventional chemistry for organics (BOD) removal, metals removal, with minimal TDS addition. As the product's sludge was tested following the USEPA TCLP protocol for leachability and it passed proving the sludge could be reclassified from hazardous to nonhazardous but regulated.

General Analysis (Units in mg/L)

| | | Conventional | Product |
|---|---|---|---|
| | Untreated | Treated | Treated |
| BOD | 6,100 | 1,240 | 560 |
| TDS | 3,600 | 4,880 | 3,580 |

### Metals Analysis

| | | Conventional | Product |
|---|---|---|---|
| Constituent | Untreated | Treated | Treated |
| Cadmium | 0.141 | 0.126 | ND |
| Chromium | 2.65 | 1.32 | 0.025 |
| Copper | 10.2 | 1.86 | 0.047 |
| Lead | 4.51 | 1.45 | 0.015 |
| Nickel | 3.05 | 1.26 | 0.436 |
| Silver | 0.039 | 0.031 | ND |
| Zinc | 74.1 | 2.65 | 0.645 |

### TCLP Test (USEPA Method 1300/6010B)

| Constituent | Untreated |
|---|---|
| Arsenic | <1.0 |
| Barium | <2.0 |
| Cadmium | <0.10 |
| Chromium | <0.50 |
| Lead | <1.0 |
| Mercury | <0.010 |
| Selenium | <0.40 |
| Silver | <0.50 |

### Example VI

### Electroconductivity (EC) in Treated Waters

A comparison between treatments using conventional chemistry and the invention shows the difference in EC addition for treated waters by industry. The result in the table below shows the negligible amount of EC addition as compared to conventional chemistries.

| | | Conventional | Invention |
|---|---|---|---|
| Industry | Untreated | Chemistry² | Chemistry |
| Industrial Laundry³ | 1,156 | 2,250 | 1,297 |
| Chicken Processor | 970 | 1,800 | 1,150 |
| Corrugator | 2,800 | 8,000 | 3,100 |
| Bag Manufacturer | 1,000 | 1,800 | 1,100 |
| Iron Foundry | 2,000 | 2,800 | 2,100 |
| Glue Mfg | 2,000 | 8,500 | 3,200 |
| Chicken Cook Plant | 1,500 | 3,200 | 1,750 |
| Machining Coolant | 5700 | 10,500 | 6,621 |
| Milk Processor | 1,700 | 2,000 | 1,700 |

¹Units in μohm/cm
²Conventional Chemistry is acid/caustic for pH adjustment, alum or ferric, and a flocculant
³Industrial laundry data is based on an average of 5 facilities

### Example VII

### Centralized Industrial Waste Treatment Industry

This wastewater is a combination of plating, cutting oils, paint, automotive wash, printing, textile and several other industrial wastewater generators. Current treatment costs according to the USEPA published reference, ‘Economic Analysis of Effluent Limitations Guidelines and Standards for the Centralized Waste Treatment Industry’, December 1998, are at $0.18/gallon based on 205 locations across the United States and the treatability studies have shown the Floccin Products costs are less at $0.032/gallon with lower residual contaminant levels making it easier to meet the regulatory discharge limits. The invention was added ad a dosage of 2,000 ppm and the results of the tests for the treated water following the USEPA Cam 17 analysis protocol are shown in the table below:

| Analyte* | Untreated | Treated |
|---|---|---|
| Antimony | .087 | <.01 |
| Arsenic | 0.35 | <0.13 |
| Barium | 0.68 | <0.01 |
| Cadmium | 0.14 | <0.02 |
| Chromium | 8.929 | <0.03 |
| Cobalt | 1.1 | <0.01 |
| Copper | 40.850 | 0.190 |
| Lead | 0.690 | <0.10 |
| Mercury | 0.76 | <0.10 |
| Molybdenum | 4.218 | 0.450 |
| Nickel | 10.310 | <0.05 |
| Selenium | 0.938 | <0.16 |
| Silver | 0.198 | 0.021 |
| Tin | 1.874 | 0.12 |
| Titanium | 0.997 | <0.002 |
| Vanadium | 0.213 | <0.05 |
| Zinc | 18.080 | 0.018 |

*Units are in mg/L

### Example VIII

### Fish Processing

The invention was tested with wastewater from a fish processing facility using 1,000 ml samples and a dosage of 20 lbs/1,000 gallons. The sample was mixed for 10 minutes and the solids were allowed to settle for 15 minutes. The water was decanted off and tested using USEPA Standard Methods: 5220B for Chemical Oxygen Demand (COD), 5210B for Biochemical Oxygen Demand (BOD), 1664 (MDL 1.4 mg/L) for Total Oil and Grease and 2540D for Total Suspended Solids (TSS). The results shown in the table below proves a high contaminant removal efficiency for these constituents:

| Constituent | Untreated¹ | Treated |
|---|---|---|
| Chemical Oxygen Demand | 76,430 | 4,410 |
| Biochemical Oxygen Demand | 65,000 | 4,360 |
| Total Oil and Grease | 26,360 | 27.4 |
| Total Suspended Solids | 20,150 | 405 |

¹units in mg/L

The treatment compositions noted above may be used in both batch and continuous treatment processes by dosing at a rate proportional to the level of contaminants. This should be done in a laboratory type setting for dosage quantification and analytical verification.

Batch processes typically require mixing the composition and waste stream over a period of about 1 to 15 minutes. A floc is quickly formed which then forms a highly stabilized sludge that can be filtered, dried and disposed as a solid waste in a landfill without further treatment insofar as the sludge passes the TCLP/STLC test and the treated water can be immediately reused or drained into a sewer since it meets or exceeds the regulatory levels for discharge. In a continuous process, a floc is formed in a clarifier (settling process) or air floatation unit (floating process) and the effluent from these liquid/solids separation steps can be discharged directly into a POTW collection system. The resulting sludge can be removed from the liquid/solids separation step and dewatered. The contaminants in the sludge are well stabilized and pass the TCLP/STLC testing allowing the sludge to be reclassified as nonhazardous. The product can easily treat waster with a continuous flow in excess of 5,000 gallons/minute. Using either a batch or continuous process, the treatment composition formulated according to the teachings above can remove a very wide range of contaminants. Such contaminants include oil and/or grease, soluble and insoluble organics, all CAM 17 heavy metals, phosphates, chromium (VI), arsenic and selenium, precious metals, and pigments from paints and dyes. The invention does not alter the waters levels of EC and TDS significantly versus other chemistries. All of the above contaminants can be removed from raw water, municipal wastewater, industrial wastewater, contaminated ground water and concentrated liquors in accordance with the invention.

There has been disclosed heretofore the best embodiment of the invention presently contemplated. However, it is to be understood that various changes and modifications may be made thereto without separation from the spirit of the invention.

1. A composition for the removal of contaminants from waters, comprised of the following:
one or more naturally occurring clays;
one or more inorganic metal salt;
one or more organic compound

2. The composition of claim 1, wherein said clay comprise of up to 96% by weight and has these properties:
a) Moisture 6-20%
b) Swell Index: 15-30%
c) Plate Water Absorption: 700-1,000% by weight @ 20 degrees C/18 hours
d) Calcium Oxide: 0.5-1.0% as CaO
e) pH of 6% by weight solution: 8.5-9.8 pH
f) Specific Gravity: 2.5-3.0
g) Bulk Density: 64 lbs/cubic foot

3. The compositions of claim 2, wherein said natural clay also consists of varied amounts of silica, quarts, albite, cristobalite, biotite, and mica.

4. The composition of claim 2 further comprising of Monoclinic structure, space group C2/m (no. 12), a=5.200 angstrom, b=9.200 angstrom, c=10.130 angstrom, alpha=90.00, Beta=99.00 and gamma=90.00.

5. The composition of claim 2 further comprising of atomic positional parameters as shown in the table below:

| | | | |
|---|---|---|---|
| Al | 0.000 | 0.333 | 0.000 |
| K | 0.500 | 0.000 | 0.500 |
| Mg | 0.000 | 0.000 | 0.000 |
| 01 | 0.481 | 0.500 | 0.320 |
| 02 | 0.172 | 0.728 | 0.335 |
| 03 | 0.348 | 0.691 | 0.110 |
| OH | 0.419 | 0.000 | 0.105 |
| Si | 0.417 | 0.329 | 0.270 |

6. The composition of claim 1 further comprising up to 40% by weight of metal salts. The composition of claim 6 further comprising of coagulating compound.

8. The composition of claim 1, further comprising up to 11% by weight of an organic compound.

9. The composition of claim 8, further comprising a flocculating agent.

10. The composition of claim 8, wherein said organic compound comprises one or more from the group consisting of anionic, nonionic, and cationic polymers.

11. A composition for the removal of contaminants from water(s), comprising an effective amount by weight percent of the following; from 15-90% natural clay; from 1-40% coagulants; from 1-11% flocculating agent.

12. The composition of claim 11, wherein said natural silicate comprises one or more hydro-phyllosilicates selected from the group consisting of natural clay and other trace minerals. This pyrophyllite-type structure with end member formula Al₄Si₈0₂₀(OH)₄.nH₂O, allows substitutions in either or both octahedral and tetrahedral layers which allows weak bonding of exchangeable cations (ion exchange) in the interlayer mica positions. Interlayer water or cation exchange occurs readily, with accompanying large changes in the c-dimension.

13. The composition of claim 11 wherein said coagulant comprises one or more coagulants selected from the group consisting of inorganic coagulants and organic coagulants.

14. The composition of claim 11, wherein said inorganic coagulants comprise iron compounds and/or aluminum compounds.

15. The composition of claim 13, wherein said organic coagulants comprise low molecular weight cationic polyelectrolytes.

16. The composition of claim 13, wherein said coagulant comprises one or more coagulants selected from the group consisting of ferrous sulfate, ferric chloride, aluminum chlorohydrate, polyaluminum chloride and aluminum sulfate.

17. The composition of claim 13, wherein said coagulant comprises one or more coagulants selected from the group consisting of polyamine, polydiallyldimethylammonium chloride, and polyepichlohydrin.

18. The composition of claim 11, wherein said flocculating agent comprises one or more polyelectrolytes selected from the group consisting of nonionic, anionic and cationic polyelectrolytes.

19. The composition of claim 18, wherein said flocculating agent comprises one or more polyelecyrolytes selected from the group consisting of hydrolyzed polyacrylamide and/or polyacryloylethylammonium chloride.
